(19) United States
(12) Patent Application Publication
(10) Pub. No.: US 2026/0318578 A1
(43) Pub. Date: Oct. 15, 2026

(54) Test Bench for Vapor-Compression Heat Pump and Refrigeration Systems with an Energy-Efficient Water Mixing System

(71) Applicant: IGOR VALIGUN, Oviedo, FL (US)

(72) Inventor: IGOR VALIGUN, Oviedo, FL (US)

(21) Appl. No.: 19/177,588

(22) Filed: Apr. 13, 2025

(51) Int. Cl. F25B 49/02; F25B 25/00; G01M 99/00

(52) U.S. Cl. CPC F25B 49/02; F25B 25/005; G01M 99/005

(57) ABSTRACT

A test bench for evaluating vapor-compression heat pumps and refrigeration systems operating in a water-to-water configuration is disclosed. The system includes three water tanks: a cold-side tank, a hot-side tank, and a central buffer tank maintained at ambient temperature by a low-power chiller. The system dynamically redistributes heat between the evaporator and condenser loops by controlled mixing of water between the tanks using servo valves and three-way valves. Flow meters and temperature sensors enable real-time calculation of thermal energy exchange and system performance. This configuration eliminates the need for high-power heating and cooling equipment, resulting in over 80% energy savings compared to traditional test benches. The system supports stable, precise simulation of operating conditions for standalone air conditioners and heat pumps, allowing accurate measurement of coefficient of performance (COP) and system behavior under various load conditions.

### FIELD OF THE INVENTION

The present invention relates to the field of refrigeration technology, and more particularly to test benches for evaluating the performance of vapor-compression refrigeration systems, including standalone air conditioners and heat pumps operating in a water-to-water configuration.

### BACKGROUND OF THE INVENTION

Traditional test benches for refrigeration and heat pump systems require large external heating and cooling devices to maintain stable water temperatures in the evaporator and condenser circuits. These systems are typically based on ASHRAE Standard 23.1 and AHRI Standard 540, and consume considerable amounts of energy—often exceeding 7 kW—due to the need to compensate for thermal loads with electric heaters and chillers.

Conventional configurations generally rely on two separate water tanks: one supplying water to the condenser (which needs to be cooled), and the other supplying water to the evaporator (which needs to be heated). This setup requires significant energy input to maintain target conditions, increases equipment complexity and cost, and presents challenges for accurately simulating dynamic operating conditions.

### SUMMARY OF THE INVENTION

The invention provides a highly energy-efficient test bench that simulates real-world thermal conditions for vapor-compression refrigeration systems by using a closed-loop water system with dynamic heat redistribution. Instead of relying on powerful external heaters and chillers, the system employs a third, central water tank to buffer and redistribute heat between the condenser and evaporator circuits through controlled mixing of water flows.

The system consists of three water reservoirs: a cold-side tank connected to the evaporator loop; a hot-side tank connected to the condenser loop; a large central buffer tank at ambient (room) temperature When the temperature in the cold-side tank drops below a preset threshold (e.g., 40 °F), excess cold water is diverted into the buffer tank via a three-way valve, while an equal volume of room-temperature water is drawn from the buffer tank and injected back into the cold tank to maintain thermal stability.

The hot-side tank operates symmetrically: when its temperature exceeds a certain threshold, hot water is diverted into the buffer tank and replaced with cooler buffer water to maintain target conditions at the condenser inlet.

The buffer tank is actively cooled by a compact chiller rated for the compressor's electrical power (e.g., ~1 kW), making the system vastly more energy-efficient than traditional setups requiring simultaneous heating and cooling (e.g., 3 kW+4 kW).

All water flows between tanks are monitored by flow meters, allowing precise calculation of thermal energy transferred in each direction. Temperature and pressure sensors monitor refrigerant and water conditions throughout the system.

### BRIEF DESCRIPTION OF THE DRAWINGS

FIG. 1 illustrates the refrigeration circuit of the test bench, including the compressor, condenser, evaporator, and refrigerant-side instrumentation.

FIG. 2 shows the water-side configuration of the system, including the cold, hot, and buffer tanks, chiller, mixing valves, flow meters, and pump loops.

### DETAILED DESCRIPTION OF THE PREFERRED EMBODIMENT

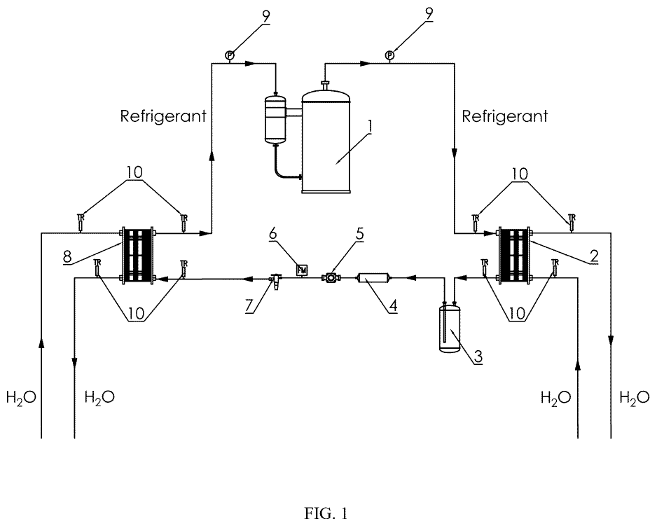

Referring to FIG. 1, the test bench comprises a vapor-compression refrigeration loop that includes a rotary inverter-driven compressor (1), a plate-type condenser heat exchanger (2), and a plate-type evaporator heat exchanger (8). Refrigerant exiting the compressor (1) enters the condenser (2), where it transfers heat to the water circuit. The condensed refrigerant then passes through a receiver (3), a dryer (4), a sight glass (5), a liquid flow meter (6), and a thermostatic expansion valve (7) before entering the evaporator (8). Inside the evaporator, the refrigerant absorbs heat from the cold-water loop, evaporates, and returns to the compressor, completing the cycle.

Temperature sensors (10) and pressure sensors (9) are placed at strategic points along the refrigerant loop to monitor system performance.

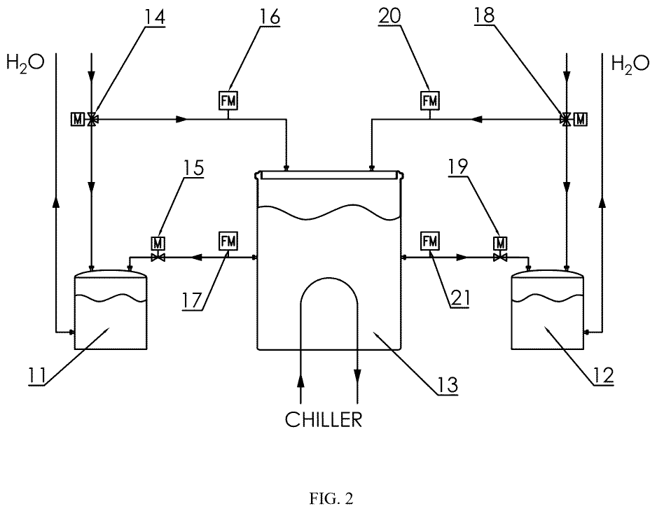

Referring to FIG. 2, the water-side of the system includes three tanks:
Cold water tank (11), hydraulically connected to the evaporator (8)
Hot water tank (12), connected to the condenser (2)
Central buffer tank (13) with a large thermal mass and connected to a chiller for temperature control

During operation, water is circulated through the evaporator (8) from the cold tank (11). If the temperature in tank (11) drops below a predefined threshold (e.g., 5 °C), a three-way valve (14) redirects the overcooled water into the buffer tank (13). Simultaneously, a servo valve (15) opens and delivers an equal amount of room-temperature water from tank (13) back into the cold tank. Water flow volumes are measured by flow meters (16, 17).

The hot tank (12) operates similarly. Water that becomes excessively hot in the condenser (2) is diverted into the buffer tank (13) via a three-way valve (18), and replaced by an equal volume of cooler water from the buffer tank via valve (19). Flow meters (20, 21) register the exchanged water volume, which-combined with inlet and outlet temperatures-allows precise calculation of energy exchanged in both loops.

The buffer tank (13) is cooled by a low-power chiller and equipped with internal circulation to ensure even temperature distribution and avoid thermal stratification.

This configuration enables accurate simulation of real operating conditions without the need for bulky and power-hungry thermal control equipment. It allows for consistent and stable water temperatures in both heat exchangers, reducing total energy consumption and improving test accuracy.

### Advantages Over Prior Art

Energy savings exceeding 80% by eliminating separate heating and cooling systems
Dynamic thermal control via smart mixing instead of brute-force temperature correction
Compact and modular design, adaptable to a wide range of HVAC and heat pump systems
High precision in performance measurements, including refrigerant-side and water-side parameters
Full compliance with ASHRAE Standard 23.1, AHRI Standard 540, and ASHRAE 41.1
Reduced system complexity and cost due to elimination of redundant equipment

1. A test bench system for evaluating vapor-compression heat pumps and refrigeration systems, comprising:
a refrigeration circuit including a compressor, a condenser, and an evaporator;
a cold-side water tank hydraulically connected to the evaporator;
a hot-side water tank hydraulically connected to the condenser;
a buffer water tank maintained at a target intermediate temperature by a chiller;
at least one three-way valve configured to redirect water from the cold-side or hot-side tank to the buffer tank;
at least one servo-controlled valve configured to deliver an equal volume of water from the buffer tank back into the respective tank;
flow meters installed along water exchange paths;
temperature sensors installed at the inlet and outlet of the condenser and evaporator;
a control unit configured to manage water exchange based on measured temperatures to maintain predefined thermal conditions in the cold-side and hot-side tanks.

2. The system of claim 1, wherein the control unit activates the three-way and servo-controlled valves when the water temperature in either the cold-side or hot-side tank exceeds a preset threshold.

3. The system of claim 1, wherein the buffer tank includes an internal circulation system to maintain temperature uniformity.

4. The system of claim 1, wherein the chiller is dimensioned to match or slightly exceed the electrical power of the compressor.

5. The system of claim 1, wherein the flow meters are configured to calculate thermal energy transferred by combining flow volume and temperature difference.

6. The system of claim 1, wherein the refrigeration circuit further includes a liquid receiver, a filter dryer, a sight glass, and a thermostatic expansion valve.

7. The system of claim 1, further comprising a data logging module configured to record temperature, pressure, and flow rate values.

8. The system of claim 1, wherein the control unit includes programmable hysteresis settings to reduce valve cycling.

9. The system of claim 1, wherein the test bench is compatible with multiple refrigerants including R32, R410A, and R1234yf.

10. The system of claim 1, wherein the test bench is compliant with ASHRAE Standard 23.1 and AHRI Standard 540 test procedures.

11. A method for testing vapor-compression heat pumps and refrigeration systems using a water-to-water test bench, comprising the steps of:
operating a refrigeration circuit including a compressor, condenser, and evaporator;
circulating water through the condenser and evaporator from separate hot-side and cold-side tanks;
maintaining a buffer tank at a stable intermediate temperature using a chiller;
monitoring water temperatures in the hot-side and cold-side tanks;
when the temperature in either tank exceeds a predefined threshold, redirecting an equivalent volume of water from that tank into the buffer tank;
and simultaneously replacing the removed volume with water from the buffer tank to restore thermal balance.
